(19) United States
(12) Patent Application Publication
(10) Pub. No.: US 2004/0097603 A1
(43) Pub. Date: May 20, 2004

(54) Ion-exchange fluororesin membrane

(76) Inventors: Takuya Hasegawa, Yokohama (JP); Yuichi Inoue, Yokohama (JP)

Correspondence Address: BIRCH STEWART KOLASCH & BIRCH, PO BOX 747, FALLS CHURCH, VA, 22040-0747, US

(21) Appl. No.: 10/467,450

(22) PCT Filed: Feb. 7, 2002
(86) PCT No.: PCT/JP02/01029

(30) Foreign Application Priority Data
Feb. 7, 2001 (JP) 2001-30426

(51) Int. Cl. C08J 5/20

(52) U.S. Cl. 521/27

(57) ABSTRACT

An ion exchange fluorocarbon membrane having a membrane thickness of 1 to 500 μm, an equivalent puncture strength of at least 300 g and a thermal shrinkage in air at 160° C. of 45% or less.

### TECHNICAL FIELD

The present invention relates to an ion exchange fluorocarbon resin membrane used as an electrolyte and a diaphragm of a solid polymer type of fuel cell, in particular an intermediate raw material or a precursor composition of an ion exchange fluorocarbon resin membrane having excellent performance as an electrolyte and a diaphragm.

### PRIOR ART

A fuel cell is a sort of electric generator which generates electric energy by electrochemically oxidizing fuels such as hydrogen and methanol and has lately attracted attention as a clean energy source. The fuel cell is classified into a phosphoric acid type, a molten carbonate type, a solid oxide type, a solid polyelectrolyte type or the like depending on the kind of the electrolyte to be used, and among them the solid polyelectrolyte type of fuel cell is expected to be widely applied as a power source of an electric vehicle or the like because of a low standard operating temperature of 100° C. or less and a high energy density thereof.

The solid polyelectrolyte type of fuel cell is basically composed of an ion exchange membrane and a pair of gas diffusion electrodes bonded to both sides thereof, and generates electricity by supplying hydrogen to one electrode and oxygen to the other electrode and connecting both electrodes to an external load circuit. More specifically, a proton and an electron are generated in the hydrogen side electrode. The proton migrates through the ion exchange membrane to the oxygen side electrode, and then reacts with oxygen to form water, while the electron flows through a lead wire from the hydrogen side electrode and discharges electric energy in the external load circuit and then arrives at the oxygen side electrode through another lead wire, resulting in contributing to the proceeding of the above water-forming reaction. Although a required characteristic of the ion exchange membrane is high ion conductivity in the first place, high water content and high water dispersibility in addition to the ion conductivity are also important required characteristics because the proton is considered to be stabilized by hydration of a water molecule when migrating through the ion exchange membrane. In addition, since the ion exchange membrane also plays the role of a barrier to prevent direct reaction of hydrogen and oxygen, low gas permeability is required. Furthermore, properties such as chemical stability to resist a strongly acidic atmosphere during the fuel cell operation and mechanical strength to meet the requirements for a thinner membrane are also necessary.

An ion exchange fluorocarbon resin is widely employed as a material for the ion exchange membrane to be used for the solid polyelectrolyte type of fuel cell, because of a high chemical stability thereof, and particularly “Nafion” (registered trademark) made by DuPont Co. having a perfluorocarbon as a main chain and a sulfonic acid group at an end of a side chain is broadly used. Although such ion exchange fluorocarbon resin has generally mostly balanced properties as a solid polyelectrolyte material, further improvements in the properties thereof have been required with the progress in the practical use of said fuel cell.

For example, thinning of the ion exchange membrane will increasingly become more important to attain high levels of current density and uniform water content within a membrane, which requires further improvement of mechanical strength of the ion exchange membrane. Higher strength is also required from the viewpoint of improvement of long-term durability. Stretching technology is an effective means to improve mechanical strength of a membrane or film, and methods for obtaining a high strength ion exchange membrane by stretching are already known. JP-A-60-149631 discloses a manufacturing method in which an ion exchange membrane swollen with a liquid organic compound or a melt-moldable ion exchange resin precursor swollen with a fluorine-containing liquid organic compound is stretched at least in a direction within a plane.

In Example 1 of said application, it is also disclosed that the mechanical strength of an ion exchange fluorocarbon resin is enhanced from 2.8×10⁷ Pa to 6.3×10⁷ Pa by stretching by 2×2 times in longitudinal and lateral directions at 125° C. The stretched membrane in accordance with said Example, however, clearly shows large thermal shrinkage. For example, such problems have been found that the stretched membrane loses flatness due to a large shrinkage when it is exposed to the temperature corresponding to the heat-press temperature in preparation of a membrane/electrode assembly (MEA), or the membrane shrinks in a hot water (see Comparative Example 4 in the present specification). The above-described application discloses in Example 13 thereof that the mechanical strength of an ion exchange fluorocarbon resin membrane precursor is increased from 3.3×10⁷ Pa to 3.5×10⁷ Pa by stretching by 2×2 times in longitudinal and lateral directions at 70° C. The enhancement in mechanical strength, however, is remarkably smaller than the case of the stretched membrane in Example 1, showing the problem of difficulty in attaining a high strength due to great orientation relaxation (see Comparative Example 2 in the present specification). JP-B-63-61337 discloses “a method for manufacturing an ion exchange membrane characterized by thinning a membrane comprising an ion exchange fluorocarbon resin “precursor” containing uniformly dispersed fibrillated fluorocarbon resin fibers by stretching at a specified temperature”. Said publication, however, mainly aims at thinning of an ion exchange membrane and thus mechanical strength is lower than that of a non-stretched membrane as shown in Table 3 of said application. This result is in good coincidence with those in Example 13 of the above-described JP-A-60-149631 application, wherein a precursor is similarly used. As described above, the conventional technologies for enhanced strength are within an attempt only for stretching and thus can not be a disclosure of an industrially useful technology as an ion exchange membrane for a fuel cell, because, in particular, stabilization of stretching orientation is not sufficient and thermal shrinkage is too large.

### DISCLOSURE OF THE INVENTION

An object of the present invention is to provide an ion exchange fluorocarbon resin membrane superior in mechanical strength, dimensional stability and ion conductivity.

Stretching technology to orient molecular chains to a specified direction is an effective way to enhance film strength, but any of the conventional technologies attempted for an ion exchange fluorocarbon resin membrane were incomplete, as described above. As a reason thereof, it is pointed out that stabilization of the stretching orientation was insufficient. The present inventors paid attention to this point, and found after extensive study a method for effective stabilization of stretching orientation, and thus accomplished an ion exchange fluorocarbon resin membrane of the present invention.

Namely, the first aspect of the present invention is an ion exchange fluorocarbon resin membrane with a membrane thickness of 1 to 500 μm, an equivalent puncture strength of at least 300 g and a thermal shrinkage in air at 160° C. of 45% or less. A preferred aspect of this invention is an ion exchange fluorocarbon resin membrane with a horizontal ion conductivity at 80° C. of at least 0.10 S/cm or an ion exchange fluorocarbon resin membrane with a horizontal swelling ratio in hot water at 80° C. of from −10% to 30%. Another preferred aspect of the present invention is an ion exchange fluorocarbon resin membrane with a strength retention ratio in hot water at 80° C. of at least 80% or an ion exchange fluorocarbon resin membrane with an ion conductivity anisotropy in hot water at 80° C. of 1.00 or more.

The second aspect of the present invention is directed to the above-described method for manufacturing an ion exchange fluorocarbon resin membrane from an ion exchange fluorocarbon resin resin precursor, comprising a heat treatment of an intermediate (a membrane of ion exchange fluorocarbon resin precursor) of said ion exchange fluorocarbon resin membrane at a temperature of at least an α-dispersion temperature. Preferably, the above-described manufacturing method comprises: 1) a step for film-formation of an ion exchange fluorocarbon resin precursor containing an ion exchange group precursor; 2) a step for orienting said precursor membrane; 3) a step for obtaining an ion exchange membrane by hydrolysis of an ion exchange group precursor under a constraint to maintain the oriented condition of said precursor membrane; and 4) a step for heat treatment of said ion exchange membrane under a constraint. Preferably, the above-described manufacturing method also comprises: 1) a step for film-formation of an ion exchange fluorocarbon resin precursor containing an ion exchange group precursor; 2) a step for obtaining an ion exchange membrane by hydrolysis of an ion exchange group precursor of said precursor membrane; 3) a step for orienting said ion exchange membrane; and 4) a step for a heat treatment of said ion exchange membrane under a constraint. More preferably, the above-described manufacturing method further comprises: 5) a step for washing the membrane after the above-described heat treatment step. Even more preferably, the above-described manufacturing method comprises a contact with an acidic aqueous solution at least in a part of the above-described washing process.

The third aspect of the present invention is directed to a membrane/electrode assembly using an ion exchange fluorocarbon resin membrane prepared by a method in accordance with the first or the second aspect. The fourth aspect of the present invention is directed to a solid polyelectrolyte type of fuel cell using an ion exchange fluorocarbon resin membrane prepared by a method in accordance with the third aspect.

### BRIEF DESCRIPTION OF THE DRAWINGS

FIG. 1 A is a photograph by a transmission type of microscope for a cross-section of an ion exchange membrane obtained from a non-stretched precursor.

FIG. 1B is a photograph by a transmission type of microscope for a cross-section of an ion exchange membrane obtained from a stretched precursor.

### BEST MODE FOR CARRYING OUT THE INVENTION

Firstly, an ion exchange fluorocarbon resin membrane of the present invention will be described.

A film furnished with stretching orientation expresses a high mechanical strength, but it has a limitation, in many cases, for such applications as accompanied with a high temperature processing, in particular for fuel cell application, due to large thermal shrinkage. An ion exchange fluorocarbon resin membrane of the present invention, on the other hand, has the potential to be suitably applied in particular, for example, as an ion exchange membrane for fuel cell, because it has a high mechanical strength and a dimensional stability without losing superior characteristics of a usual ion exchange fluorocarbon resin membrane.

(Membrane Thickness)

The membrane thickness of an ion exchange fluorocarbon resin membrane of the present invention is 1 to 500 μm, preferably 5 to 100 μm and more preferably 10 to 50 μm. A membrane thickness below 1 μm tends to cause the above-described trouble due to a diffusion of hydrogen or oxygen, along with troubles such as a damage of membrane by a pressure difference and strain during handling of fuel cell in manufacturing or in operation thereof. On the other hand, a membrane thickness above 500 μm may have an insufficient performance as an ion exchange membrane because the membrane typically has a low ion permeability.

(Equivalent Puncture Strength)

The equivalent puncture strength (a converted value per 25 μm of a puncture strength in dry state) of an ion exchange fluorocarbon resin membrane of the present invention is at least 300 g, preferably at least 350 g and more preferably at least 400 g. An equivalent puncture strength below 300 g leads to insufficient mechanical strength for thinning of membrane and is not preferable because it requires a thicker membrane. An upper limit of equivalent puncture strength is not particularly limited in the present invention, but a membrane with a strength of at least 3,000 g is generally presumed to have a low water content and thus insufficient performance as an ion exchange membrane.

(Thermal Shrinkage at 160° C.)

The thermal shrinkage in air at 160° C. of an ion exchange fluorocarbon resin membrane of the present invention is 45% or less, preferably 40% or less, more preferably 35% or less and even more preferably 30% or less. Thermal shrinkage in oil at 160° C. of an ion exchange membrane of the present invention is preferably 20% or less, more preferably 15% or less and even more preferably 10% or less. A thermal shrinkage in air at 160° C. above 45% or thermal shrinkage in oil at 160° C. above 20% tends to generate thermal shrinkage in applications accompanied with high temperature processing and may bring about serious trouble, for example, in manufacturing MEA. A lower limit of thermal shrinkage is not particularly limited in the present invention, but a swelling ratio in a horizontal direction within a plane can be as small as 0% when an optimum heat treatment is provided. An excess heat treatment, however, may lower mechanical strength due to a relaxation of molecular orientation, and thus it is preferable to find out optimal heat treatment conditions depending on each application.

(Horizontal Ion Conductivity in Hot Water at 80° C.)

The horizontal ion conductivity in hot water at 80° C. of an ion exchange fluorocarbon resin membrane of the present invention is preferably at least 0.10 S/cm, more preferably at least 0.15 S/cm, even more preferably at least 0.20 S/cm and still more preferably at least 0.25 S/cm. A horizontal ion conductivity below 0.10 S/cm leads to an increase in internal resistance when used as an ion exchange membrane for a fuel cell, and thus is not preferable. Even when the horizontal ion conductivity is lowered by a heat treatment, it can be recovered by a washing treatment.

(Vertical Ion Conductivity in Hot Water at 80° C.)

The vertical ion conductivity in hot water at 80° C. of an ion exchange fluorocarbon resin membrane of the present invention is preferably at least 0.10 S/cm, more preferably at least 0.15 S/cm, even more preferably at least 0.20 S/cm and still more preferably at least 0.25 S/cm. A vertical ion conductivity below 0.10 S/cm leads to an increase in internal resistance when used as an ion exchange membrane for a fuel cell and thus is not preferable. Even when the vertical ion conductivity is lowered by a heat treatment, it can be recovered by a washing treatment.

(Ion Conductivity Anisotropy in Hot Water at 80° C.)

The ion conductivity anisotropy in the present invention is preferably at least 1.00, more preferably at least 1.05, even more preferably at least 1.10 and still further preferably at least 1.20. A higher ion conductivity anisotropy provides a better ion conductivity in a horizontal direction and a greater amount of water molecules are transported in a membrane accompanied to an ion conduction, resulting in an uniform retention of water distribution in a membrane even when the fuel cell is operated in a dry atmosphere.

(Horizontal Swelling Ratio in Hot Water at 80° C.)

The horizontal swelling ratio in hot water at 80° C. of an ion exchange fluorocarbon resin membrane of the present invention is preferably from −10% to 30%, more preferably from −5% to 20% and even more preferably from 0% to 10%. A horizontal swelling ratio in hot water at 80° C. larger than 30% tends to cause troubles such as generation of wrinkles caused by a strain due to wetting of an ion exchange fluorocarbon resin membrane in manufacturing of a fuel cell or by a strain due to a change in water distribution during fuel cell operation. On the other hand, a case when a minus horizontal swelling ratio, namely, a shrink behavior of membrane is observed, in particular, in such degree as lower than −10%, may be not preferable because a certain degree of shrinking stress is generated in a horizontal direction in a fuel cell. Further, a remarkable shrink behavior may be proof of a release of stretching orientation. The horizontal swelling ratio can be as small as 0% when an optimum stretching orientation and fixation thereof are attained, and thus such membrane is preferable as an ion exchange membrane for a fuel cell.

(Vertical Swelling Ratio in Hot Water at 80° C.)

The vertical swelling ratio in hot water at 80° C. of an ion exchange fluorocarbon resin membrane of the present invention is preferably 100% or less, more preferably 75% or less and even more preferably 50% or less. A vertical swelling ratio in hot water larger than 100% may not be preferable due to generation of a large pressure caused by wetting of an ion exchange fluorocarbon resin membrane in manufacturing of a fuel cell or a change in water distribution during an operation of a fuel cell. The lower limit of vertical swelling ratio is not particularly limited in the present invention, but the ratio is preferably at least 0%, more preferably at least 5% and even more preferably at least 10%, in view of adhesion between an ion exchange fluorocarbon resin membrane and an electrode.

(Strength Retention Ratio in Hot Water at 80° C.)

The strength retention ratio in hot water at 80° C. of an ion exchange fluorocarbon resin membrane of the present invention is preferably at least 80%, more preferably at least 85%, even more preferably at least 90% and still more preferably at least 95%. A strength retention ratio in hot water lower than 60% is not preferable, because lowering in strength may take place when a fuel cell is operated at a high temperature.

(Water Content)

The water content of an ion exchange fluorocarbon resin membrane of the present invention is preferably at least 5% by weight, more preferably at least 10% by weight, even more preferably at least 15% by weight and still more preferably at least 20% by weight. A too low water content of an ion exchange membrane leads to a decrease in power output when pressures of oxygen and hydrogen are low or air is used as an oxygen source. It is also not preferable because ion conductivity or gas permeability easily changes by a slight change in operational conditions. A water content in the above-described preferable range can retain a high power output without lowering in an output voltage even in cases of high current density, low pressure, non-humidification and use of air as an oxygen source. As a reason for this, it is supposed that water easily migrates in an ion exchange membrane because a water content is sufficient or shortage of water hardly occur. A water content of 250% or more, however, tends to weaken membrane strength and cause an abrupt increase in the permeability coefficient of oxygen gas or hydrogen gas, whereas ion conductivity tends to be not increased so much. Therefore, the upper limit of water content is not particularly limited, but preferably 250% and more preferably 200%.

(Equivalent Weight)

The equivalent weight (EW) of an ion exchange fluorocarbon resin membrane of the present invention is not particularly limited, but is preferably 400 to 1,400, more preferably 600 to 1,200, and even more preferably 700 to 1,000. A higher equivalent weight enhances mechanical strength of even a non-oriented membrane, but reduces ion conductivity due to lowering the density of ion exchange groups at the same time.

(Features of an Oriented Membrane)

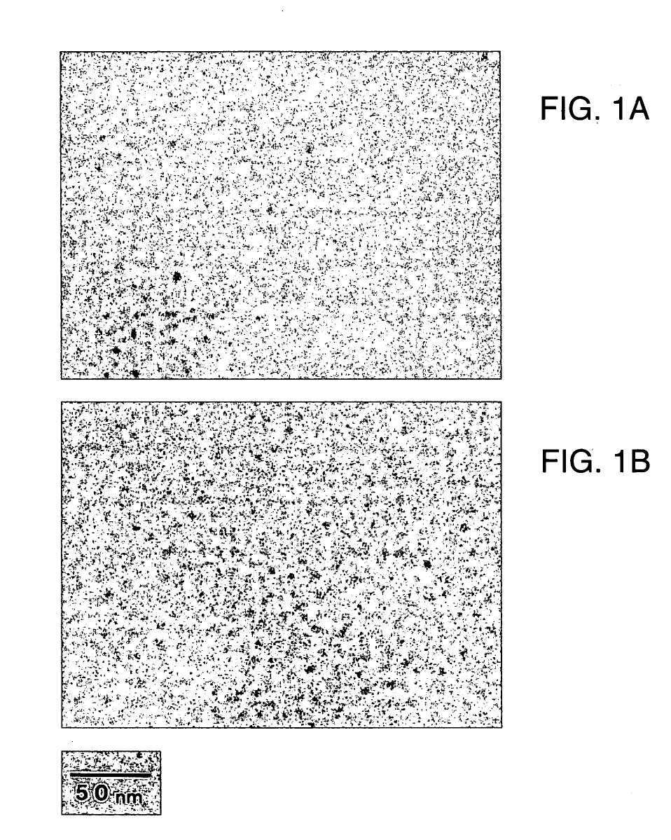

An ion exchange fluorocarbon resin membrane of the present invention is superior in mechanical strength, dimensional stability and ion conductivity and thus suitably used as an ion exchange membrane for a fuel cell. One of the features of the ion exchange fluorocarbon resin membrane of the present invention is, in particular, horizontal ion conductivity, which tends to be higher, in most cases, than that of a non-oriented membrane with the same levels of ion exchange capacity and water content. The reason for this has not yet been clarified, but it is considered that a mutual interference of clusters deformed in a horizontal direction by the combination of stretching and hydrolysis may contribute to an improvement of ion conductivity in a horizontal direction. This hypothesis can be supported by an anisotropy of membrane between a thickness direction and a horizontal direction observed in a small angle X-ray scattering image (which seems to correspond to a cluster structure) taken from a cross-sectional face of membrane, and an intensity pattern corresponding to a cluster structure showing a characteristic continuous structure in a microphotograph by a transmission type of electron microscope taken from a cross-sectional face of a membrane. Such hypothesis, however, should never limit the present invention. In addition, it is known that a small angle X-ray scattering image of a non-oriented membrane in general does not show an anisotropy between a thickness direction and a horizontal direction, and a microphotograph by a transmission type of electron microscope shows a characteristic sea-island structure. For reference, FIGS. 1A and 1B show microphotographs by a transmission type of electron microscope (Hitachi HF-2000; acceleration voltage 200 kV; magnification 250,000 times) of cross-sections of ion exchange membranes obtained by hydrolyzing a non-stretched precursor membrane and by hydrolyzing a stretched precursor membrane in accordance with the present invention.

Next, a method for manufacturing an ion exchange fluorocarbon resin membrane of the present invention will be described.

An ion exchange membrane is prepared by film-formation of an ion exchange resin precursor, followed by hydrolysis at a high temperature. Materials to be stretched are therefore classified largely to an ion exchange fluorocarbon resin precursor before hydrolysis and an ion exchange fluorocarbon resin after hydrolysis, and both materials can be stretched in the present invention depending on purpose. They are selected as follows.

(Stretching of an Ion Exchange Fluorocarbon Resin Precursor)

The first embodiment of preferable stretching in the present invention is performed on an ion exchange fluorocarbon resin precursor. A particularly important point in stretching of an ion exchange fluorocarbon resin precursor is prevention of orientation relaxation after completion of stretching. This is because the stretching temperature of a film is often generally set based on a α-dispersion temperature determined by a viscoelastic measurement. The α-dispersion temperature here is a temperature at which main chains of a polymer seem to begin thermal motion and is widely used as an index in polymer processing accompanied with a large polymer strain such as stretching. For example, the α-dispersion temperature of such polymers as represented by polyester and nylon is generally far higher than room temperature, and enables a great deal of reduction in thermal motion of main chains by cooling down to a temperature below the α-dispersion temperature after completion of stretching, and thereby an effective stabilization of stretching orientation.

On the other hand, the α-dispersion temperature of an ion exchange fluorocarbon resin precursor exists at around room temperature, and makes such “fixation of stretching orientation” difficult, and thus removal of a constraint under a stretched state results in an abrupt shrinkage to lose stretching orientation in many cases. The present inventors found, after an extensive study on an orientation relaxation of an ion exchange fluorocarbon resin precursor, a novel method for fixation of stretching which does not depend on the α-dispersion temperature by paying attention to hydrolysis, which is a step of manufacturing process specific to said precursor. Namely, the first embodiment of preferable stretching in the present invention is characterized in that an ion exchange fluorocarbon resin precursor is stretched then hydrolyzed under a constraint in the stretched state.

The reason for attaining fixation of stretching by such a method is not clear, but it is considered that a reduction of thermal movement in the rising process of α-dispersion temperature of an oriented membrane with a progress of hydrolysis under a constraint of stretching orientation leads to the fixation of stretching, because the α-dispersion temperature of an ion exchange fluorocarbon resin formed by hydrolysis is far higher than that of said precursor and seems to be around 120° C. Such a method for fixation of stretching is referred to as “saponification fixation” in the present invention.

Another reason for attaining this saponification fixation is considered as follows. An ion exchange fluorocarbon resin precursor can absorb a large quantity of water after hydrolysis, which does not present uniformly in the resin but forms microscopic droplets existing locally. These droplets are called clusters, which can typically be observed by a small angle X-ray diffraction or a transmission type of microscope. One cluster seems to contain multiple side chain ends, which are expected to function as a kind of cross-linking point by being bonded each other via water, if clusters are formed after stretching of an ion exchange fluorocarbon resin precursor under a constraint. Namely, this saponification fixation seems to be more effectively realized by the function of clusters formed after stretching orientation as a pseudo cross-linking point, in addition to the rise of the α-dispersion temperature.

On the other hand, stretching orientation of an oriented membrane without the saponification fixation is largely released when released from a constraint or contacted with a saponification liquid at a high temperature, resulting in loss of strong stretching orientation and lowering of a mechanical strength to the same level to that of a non-stretched membrane. Example 13 in the above-described JP-A-60-149631 is an example of such undesirable stretching form. As Examples of the present invention will make clear, an oriented membrane provided with the saponification fixation is more superior in mechanical strength compared with an oriented membrane without the treatment of saponification fixation, and thus preferable as an ion exchange membrane for a fuel cell. Said oriented membrane is remarkably stable at around room temperature, but the dimensional stability thereof is not sufficient as an ion exchange membrane for a fuel cell when heated to a temperature of the α-dispersion temperature or more. Thus, a heat treatment process is required as described later.

(Stretching of an Ion Exchange Fluorocarbon Resin)

The second embodiment of preferred stretching in the present invention is performed on an ion exchange fluorocarbon resin. As described above, the α-dispersion temperature of an ion exchange fluorocarbon resin seems to exist at around 120° C., and easily enables fixing stretching by cooling and maintaining a high mechanical strength even after released from a constraint. Such oriented membrane is preferable, in particular, from the viewpoint of productivity improvement of an ion exchange membrane for a fuel cell, because it does not require special treatment such as saponification fixation and general stretching technology can be applied. Namely, the second embodiment of preferred stretching in the present invention is characterized by stretching of an ion exchange fluorocarbon resin precursor after hydrolysis.

On the other hand, it is observed that said oriented membrane tends to exhibit more shrinkage or lowering in mechanical strength as well as lowering in ion conductivity when subjected to high temperature and high humidity conditions with a high water content, in particular, at high temperature, than an oriented membrane treated with saponification fixation. The reason for this is not clear, but it may be because clusters received a strain by stretching after hydrolysis release the strain under hot and wet conditions. Such strain of cluster is considered to be specific to stretching of an ion exchange fluorocarbon resin. Said oriented membrane is remarkably stable at around room temperature, but the dimensional stability thereof is not sufficient as an ion exchange membrane for a fuel cell, when heated at a temperature of the α-dispersion temperature or more. Thus, heat treatment process is required as follows.

(Heat Treatment)

One of the important problems of an ion exchange membrane for a fuel cell is thermal shrinkage at high temperature. It is known, in general, that generation of thermal shrinkage is related to the α-dispersion temperature or stretching temperature of a polymer. For example, the α-dispersion temperature of an ion exchange fluorocarbon membrane is considered to be around 120° C., but MEA is prepared, in many cases, by pressing at a higher temperature such as 130 to 190° C., and thus the membrane is exposed to a higher temperature than the α-dispersion temperature, although for a short period. In such a case, generation of an abrupt orientation relaxation brings about troubles such as shrinkage of membrane or loss of flatness, causing greatly reduced productivity of a fuel cell. The present inventors found, after an extensive study on the thermal shrinkage at a high temperature, that the thermal shrinkage at a high temperature could be effectively reduced without a large reduction of mechanical strength, by combining a specific heat treatment process for an ion exchange fluorocarbon membrane prepared by the above-described two methods. Namely, the present invention is characterized in that an ion exchange fluorocarbon membrane is subjected to a heat treatment at a temperature of the α-dispersion temperature or more. A method for heat treatment may include heating of an ion exchange fluorocarbon membrane under a constraint in various kinds of media, however, a heat treatment in water is less effective due to the accompanied swelling of the ion exchange fluorocarbon membrane. Therefore, heat treatment in a liquid other than water or in gas is preferable. Among them, a method widely used in the film industry is heat treatment in air. Example 4 of the present invention shows such heat treatment.

(Washing Treatment)

However, a study by the present inventors has revealed that heat treatment of an ion exchange fluorocarbon membrane reduces ion conductivity to an insufficient level as an ion exchange membrane for a fuel cell, in some cases. The present inventors found by an extensive study on lowering of ion conductivity with heat treatment that the ion conductivity is largely recovered by a washing treatment after the heat treatment. Namely, a preferred embodiment of the present invention is characterized by a washing treatment of an ion exchange fluorocarbon resin after heat treatment.

The reason for lowering of ion conductivity with heat treatment is not clear, but it is considered as the reason that ion conductivity is lowered by adsorption of trace amounts of impurities contained in various kinds of media by ion exchange groups or dehydration condensation among ion exchange groups. Further, the reason for the recovery of ion conductivity by washing treatment is also not clear, but it is considered as a reason for the recovery of ion conductivity that the ion exchange groups adsorbing impurities are reconverted to acid type or the condensation among ion exchange groups is released by treatment with acid such as hydrochloric acid and sulfuric acid. The tendency of this lowering in ion conductivity is remarkable particularly when the heat treatment is provided at a temperature of the α-dispersion temperature or more for 30 minutes or longer. As a washing treatment, various methods may be applied as long as they do not impair the purpose of the present invention, but washing with acid is required to finally obtain acid type of ion exchange groups. A higher washing temperature is preferable, but room temperature can provide a good washing effect in many cases. Example 1 of the present invention shows such washing treatment.

(Raw Polymers)

An ion exchange fluorocarbon resin precursor used in the present invention comprises at least a binary copolymer of a fluorinated vinyl compound represented by the general formula: CF₂═CF—O(CF₂CFLO)ₙ—(CF₂)ₘ—W and a fluorinated olefin represented by the general formula: CF₂═CFZ, wherein, L is a F atom or a perfluoroalkyl group with 1 to 3 carbon atoms, n is an integer of 0 to 3, m is an integer of 1 to 3, and Z is H, Cl, F or a perfluoroalkyl group with 1 to 3 carbon atoms. Further, W is a functional group convertible to CO₂H or SO₃H by hydrolysis, and SO₂F, SO₂Cl, SO₂Br, COF, COCl, COBr, CO₂CH₃ and CO₂C₂H₅ are typically preferably used. Such an ion exchange fluorocarbon resin precursor can be synthesized by conventionally known means. For example, known methods include: a method to dissolve the above fluorinated vinyl compound in a solvent such as flons then react and polymerize with the fluorinated olefin gas (solution polymerization); a method to charge the fluorinated vinyl compound and a surfactant into water to emulsify then react and polymerize with the fluorinated olefin gas (emulsion polymerization); and further a suspension polymerization, and any of these methods can be used as a suitable method.

(Preferable Embodiment of a Manufacturing Method)

An ion exchange fluorocarbon resin membrane of the present invention is prepared by a method comprising: 1) a film-formation step; 2) a hydrolysis step; 3) an orientation step; 4) a heat treatment step; 5) a washing step; and 6) a swelling step. Among these steps, the steps of 1) to 4) are indispensable, and washing and swelling steps may be employed if necessary. The orientation step may be executed before, during or after the hydrolysis step.

(Film-Formation Step)

In order to form a membrane from an ion exchange fluorocarbon resin precursor composition, any commonly known molding method can be suitably used, including melt molding methods (T-die method, blowing method, calendaring method or the like) and a casting method. The casting method includes a method to disperse an ion exchange fluorocarbon resin in a suitable medium, or a method to form a sheet-like film from a polymerization reaction liquid itself then remove the dispersion medium. The resin temperature in melt molding by a T-die method is preferably 100 to 300°, and more preferably 200 to 280° C. The resin temperature in melt molding by a blowing method is preferably 100 to 300° C., and more preferably 160 to 240° C. A sheet melt molded by these methods is cooled to a melting temperature or less by using a chill roll or the like. The thickness of precursor membrane is preferably adjusted to an optimal value considering its reduction during the orientation step. For example, when a stretching by 4×4 times is performed in the orientation step, the thickness of a precursor membrane should be adjusted to about 400 μm to obtain an oriented membrane with a thickness of 25 μm.

(Hydrolysis Step)

As a method for hydrolysis, any commonly known methods may be used such as a method described in Japanese Patent No. 2753731, where an ion exchange group precursor of an oriented membrane is converted to a metal salt type of ion exchange group using an aqueous solution of alkali hydroxide, followed by converting to an acid type (SO₃H or COOH) of ion exchange group using an acid such as sulfonic acid and hydrochloric acid. These conversions are known to those skilled in the art and described in Examples of the present invention. When the orientation step is performed before the hydrolysis step, an ion exchange fluorocarbon resin precursor should be under a constraint throughout the hydrolysis step. Constraint in the present invention means an action to prevent a spontaneous relaxation of stretching orientation, caused by thermal shrinkage of the membrane and the like, and includes not only a constraint under a fixed dimension but also a constraint accompanied with stretching. When the orientation step is not performed before the hydrolysis step, it is necessary to prevent generation of wrinkles, in particular, in a continuous treatment using roll, belt or the like, because the membrane swells by water absorption accompanied to the hydrolysis. In the present invention, stretching or heat treatment may be performed during the hydrolysis step.

(Orientation Step)

As a method for stretching, any commonly known film stretching methods may suitably be used. Among them, more preferable methods are uniaxial transverse direction stretching using a tenter, sequential biaxial stretching using a tenter and a longitudinal stretching roll, simultaneous biaxial stretching using a simultaneous biaxial tenter and blow stretching using blow film-forming equipment. Simultaneous biaxial stretching and blow stretching are further more preferable. The suitable stretching ratio is 1.1 to 100 times, preferably 2 to 20 times and more preferably 4 to 16 times, as an area ratio. The stretching ratio in traverse direction (a perpendicular direction to machine direction) in said area ratio is 1.1 to 100 times, preferably 1.5 to 10 times and further preferably 2 to 4 times. The suitable stretching temperature is a temperature not higher than the melting temperature of the precursor membrane, preferably from (α-dispersion temperature−100° C.) to (α-dispersion temperature+100° C.). In stretching of an ion exchange fluorocarbon resin precursor, the stretching temperature is preferably −80° C. to 120° C. and more preferably 0 to 100° C. In stretching of an ion exchange fluorocarbon resin, the stretching temperature is preferably 20 to 220° C. and more preferably 70 to 170° C.

Stretching in the present invention means an elongation accompanied with generation of a stretching stress and an elongation not accompanied with generation of a stretching stress is referred to as widening. For example, when an orientation step is not performed before the hydrolysis step, the membrane swells greatly in a horizontal direction by water absorption accompanied to the hydrolysis, and an elongation of membrane corresponding to this change is considered to be widening.

(Heat Treatment Step)

As a method for heat treatment, any commonly known heat treatment methods for film may be suitably used, but heat treatment of an ion exchange fluorocarbon membrane under a constraint is preferable. The preferable heat treatment temperature is a temperature not lower than the α-dispersion temperature, and when the maximum temperature to be exposed is apparent in applications accompanied with a high temperature processing such as a press temperature in manufacturing MEA, a higher temperature than the maximum temperature is more preferable. When an ion exchange fluorocarbon resin is heated up to 300° C. or higher, deterioration may occur and thus the heat treatment temperature is preferably not higher than 300° C. More specifically, the upper limit of the heat treatment temperature is, based on the use temperature at which the membrane is used such as a press temperature, preferably not higher than the use temperature plus 50° C., more preferably not higher than the use temperature plus 30° C., even more preferably not higher than the use temperature plus 20° C. and still more preferably not higher than the use temperature plus 10° C. The lower limit of the heat treatment temperature is, based on the use temperature at which the membrane is used such as a press temperature, preferably not lower than the use temperature minus 50° C., more preferably not lower than the use temperature minus 30° C., even more preferably not lower than the use temperature minus 20° C. and still more preferably not lower than the use temperature minus 10° C. The heat treatment time depends on the heat treatment temperature, but a time in the range from about 1 second to 1 hour is employed to suitably perform the heat treatment. Longer heat treatment time and higher heat treatment temperature can reduce thermal shrinkage, but these conditions tend to cause troubles such as lowering in mechanical strength and ion conductivity. For example, the press temperature in the above-described MEA manufacturing is 130 to 160° C. in many cases. However, when shortening of heat treatment time is required to improve productivity, a desired thermal shrinkage can be attained by heat treatment at around 200° C. for 1 minute or less. In Example 4 of the present invention, the heat treatment was performed at 200° C. for 40 seconds but decreases in puncture strength and horizontal ion conductivity were 8% and 32%, respectively.

(Washing Step)

When ion conductivity is greatly lowered by the heat treatment step, it can be recovered by washing an ion exchange fluorocarbon resin membrane, if necessary. Washing may be attained, for example, by immersing the ion exchange fluorocarbon resin membrane in an aqueous acidic solution or spraying the solution to the membrane under a constraint or a non-constraint. The concentration of the aqueous acidic solution to be used depends on the degree of lowering in ion conductivity, washing temperature and washing time, but, for example, an aqueous acidic solution of 0.001 to 5 N is suitably used. Washing at room temperature provides a sufficient washing effect in many cases, but the aqueous acidic solution may be heated if the washing time should be shortened. After completion of washing treatment, the membrane is rinsed sufficiently with water to remove excess aqueous acidic solution and dried. The washing effect can be confirmed numerically, for example, as a recovery of exchange capacity or ion conductivity. As shown in Example 1 of the present invention, a lowered horizontal ion conductivity of an ion exchange fluorocarbon resin membrane in Example 4 was recovered to a level of 3% through the washing step.

(Swelling Step)

When an expression of higher ion conductivity is required, the water content in an ion exchange fluorocarbon resin membrane can be increased by performing a swelling treatment after the hydrolysis step, if necessary. For example, as in JP-A-6-342665, an ion exchange fluorocarbon resin membrane with a high water content can be obtained by heating the ion exchange fluorocarbon resin membrane in water or a mixture of water and a water-miscible organic solvent for swelling treatment, followed by converting to acid type.

(Manufacturing Method for Membrane/Electrode Assembly)

Next, manufacturing method for a membrane/electrode assembly (MEA) will be described. MEA is manufactured by bonding electrodes to an ion exchange fluorocarbon resin membrane. An electrode is composed of fine particles of a catalyst metal and a conductive agent carrying them, and additionally contains a water repellant if necessary. The catalyst used for the electrode is not particularly limited as long as it is a metal promoting an oxidation reaction of hydrogen and a reduction reaction of oxygen, and includes platinum, gold, silver, palladium, iridium, rhodium, ruthenium, iron, cobalt, nickel, chromium, tungsten, manganese, vanadium and alloys thereof. Among them, platinum is mainly used. The conductive agent may be any electron-conductive material such as various kinds of metals and carbon materials. The carbon materials include, for instance, carbon blacks such as furnace black, channel black and acetylene black; activated carbon; and graphite, and used solely or in combination thereof. The water repellant is preferably a fluorine-containing resin having water repellency, and more preferably one excellent in heat resistance and oxidation resistance. Such materials include, for instance, polytetrafluoroethylene, tetrafluoroethylene- perfluoroalkylvinylether copolymer and tetrafluoroethylene- hexafluoropropylene copolymer. As such an electrode, for instance, an electrode made by E-TEK is widely used.

MEA is manufactured from the above-described electrode and an ion exchange fluorocarbon resin membrane by, for instance, the following method. An ion exchange fluorocarbon resin is dissolved in a mixed solvent of alcohol and water to prepare a solution, in which carbon carrying platinum, as an electrode material, is dispersed to make a paste-like substance. This paste is then coated on PTFE sheets in a specified amount and dried. Then, said PTFE sheets are placed so that the coated surfaces thereof are in opposing position with an ion exchange resin membrane being sandwiched between the coated surfaces, followed by bonding thereof using a hot press. The temperature of the hot press depends on the type of ion exchange resin membrane, but usually is at least 100° C., preferably at least 130° C., and more preferably at least 150° C.

Another manufacturing method of MEA is described in “J. Electrochem. Soc. Vol. 139, No. 2, L28-L30 (1992)”. According to this method, an ion exchange fluorocarbon resin is dissolved in a mixed solvent of alcohol and water followed by converting to SO₃Na to prepare a solution, to which carbon carrying platinum is added to obtain an ink-like solution. Said ink-like solution is coated on a surface of an ion exchange fluorocarbon resin membrane which has been converted to SO₃Na type in advance, followed by removal of solvent and conversion of all ion exchange groups to SO₃H type to obtain a MEA. The present invention can be applied to such an MEA.

(Manufacturing Method for a Fuel Cell)

Next, manufacturing method for a solid polyelectrolyte type of fuel cell will be described. A solid polyelectrolyte type of fuel cell is composed of MEA, current collector, fuel cell frame, gas feed equipment and the like. The current collector (bipolar plate), among them, is a flange made of graphite or a metal, having gas passage at the surface and the like, which has a function to transfer electrons to an external load circuit and supply hydrogen or oxygen to the MEA surface. The fuel cell is prepared by inserting MEA between such current collectors and piling up a plurality of the laminates. The fuel cell is operated by feeding hydrogen to one electrode, while oxygen or air to another electrode. A higher operation temperature of the fuel cell is preferable because the catalytic activity is more enhanced, but the temperature is usually 50 to 100° C. due to an easy control of water content. On the other hand, an ion exchange membrane of the present invention may be operated at 100 to 150° C. due to an improved strength at high temperature and in high humidity. A higher feed pressure of oxygen or hydrogen is preferable due to increased output of the fuel cell, but the pressure is preferably adjusted in a suitable pressure range to reduce the probability of contact of both materials caused by a membrane failure and the like.

The present invention will be described in more detail by the following Examples.

Testing methods for the properties shown in the Examples are as follows.

(1) Membrane Thickness

Thickness of an acid type of ion exchange membrane was measured by a membrane thickness gauge (made by Toyo Seiki Seisaku-Sho Ltd.: B-1) after standing for 1 hour or more in an air-conditioned chamber controlled at 23° C. and 65% relative humidity.

(2) Equivalent Puncture Strength

An acid type of ion exchange membrane was left standing in an air-conditioned chamber controlled at 23° C. and 65% relative humidity for 12 hours or more, then a puncture test was conducted using a handy compression tester (KES-G5 made by KATO TECH Co. Ltd.) under test conditions including curvature of probe tip of 0.5 mm and puncture speed of 2 mm/sec. The puncture strength (g) was defined as the maximum puncture load. The equivalent puncture strength (g/25 μm) was calculated from the puncture strength multiplied by 25 (μm)/membrane thickness (μm).

(3) Thermal Shrinkage at 160° C.

An acid type of ion exchange membrane was left standing in an air-conditioned chamber controlled at 23° C. and 65% relative humidity for 12 hours or more, then membrane surface area before heating was measured. Then, the membrane was taken out of an oven after heating at 160° C. for 3 minutes in an oven to measure the membrane surface area after heating, taking full consideration not to absorb moisture. The thermal shrinkage in air at 160° C., Hₐ (%), was determined based on these values by the following equation:

Hₐ=((A₁−A₂)/A₂)^{0.5}×100

wherein, A₁ is membrane surface area before heating (cm²) and A₂ is membrane surface area after heating (cm²).

By a similar method, the thermal shrinkage in oil at 160° C., H_{b} (%), was determined by keeping the membrane sample in silicone oil at 160° C. for 20 minutes.

(4) Evaluation of Current-Voltage Characteristics (IV Characteristics)

A paste-like compound was prepared by mixing carbon powder carrying platinum catalyst (an amount of platinum catalyst: 40% by weight) and a solution of an ion exchange fluorocarbon resin (SS910 made by Asahi Kasei Corp., 5% by weight, solvent composition: ethanol/water=50/50) at a ratio by weight of platinum/resin being 1/1. A PTFE sheet was coated with this paste using 200 mesh screen, followed by drying at 120° C. to obtain an electrode layer with a carrying platinum amount of 0.2 mg/cm². Two sheets of PTFE forming an electrode layer were placed in opposing positions with an ion exchange membrane having a thickness of 20 to 30 μm sandwiched therebetween, pressed at 160° C. under a pressure of 60 kg/cm², followed by peeling off the PTFE sheets in both sides to obtain a MEA. A mixed liquid was prepared by mixing carbon powder, propylene glycol and PTFE dispersion liquid (content of solid component: 60% by weight) at room temperature under stirring for 1 hour. Carbon paper (thickness: 225 μm) was coated with this mixed liquid, left standing at 180° C. under reduced pressure for 1 hour, then fired by heating at 340° C. for 7 hours. The MEA was sandwiched between 2 electrode supports thus prepared and fitted up to evaluation equipment for a single fuel cell. Fuel cell performance was evaluated using hydrogen gas and air at 80° C. under normal pressure. Hydrogen and air were humidified at 70° C. and 30° C., respectively.

(5) Horizontal Ion Conductivity at 80° C.

An acid type of ion exchange membrane was cut out into strip shape with a width of 1 cm. On the surface of the membrane, 6 electrode wires with a diameter of 0.5 mm were contacted in parallel at an interval of 1 cm. After leaving the sample for standing in an air-conditioned chamber adjusted at 80° C. and 98% relative humidity for 12 hours or more, the resistance was measured by an A.C. impedance method (10 kHz), and the resistance per unit length was determined from the electrode distance and the resistance. The horizontal ion conductivity at 80° C., Z (S/cm), was calculated using this value by the following equation:

Z=1/membrane thickness (cm)/membrane width (cm)/resistance per unit length (Ω/cm).

(6) Ion Conductivity Anisotropy

By assuming the horizontal ion conductivity (0.22 S/cm) in Comparative Example 1 to be horizontal ion conductivity at 80° C. under a non-oriented state, in the following Examples and Comparative Examples, ion conductivity anisotropy was conveniently determined as a ratio of horizontal ion conductivity at 80° C. of a sample to be measured to said horizontal ion conductivity at 80° C. under a non-oriented state. Originally, true ion conductivity anisotropy should be determined as a ratio of horizontal ion conductivity to vertical ion conductivity in the same sample, however, a thin ion exchange membrane for a fuel cell, generally, tends to give an error in the measurement of vertical ion conductivity because the vertical ion conductivity is too small. Therefore, in the following Examples and Comparative Examples, ion conductivity anisotropy as measured above was adopted. However, since ion conductivity anisotropy is a feature intrinsic to an ion exchange fluorocarbon resin membrane which has a fixed stretching orientation and expresses a high strength, true ion conductivity anisotropy to be obtained when measurement accuracy for vertical ion conductivity is improved, should be considered as a physical property corresponding to the ion conductivity anisotropy of the present invention. Therefore, the term “ion conductivity anisotropy” in the present invention means not only the above-described ion conductivity anisotropy determined conveniently but also true ion conductivity anisotropy.

(7) Vertical Swelling Ratio in Hot Water at 80° C.

An acid type of ion exchange membrane was left standing in an air-conditioned chamber controlled at 23° C. and 65% relative humidity for 1 hour or more, then the membrane thickness in dry state was measured. Then, the membrane thickness in swollen state was measured under water by immersing the membrane in hot water at 80° C. for 30 minutes. The vertical swelling ratio in hot water at 80° C., Sᵥ (%), was determined from these values using the following equation:

Sᵥ=((H₁−H₂)/H₂)×100

wherein, H₁ is the membrane thickness in swollen state (μm) and H₂ is the membrane thickness in dry state (μm).

(8) Horizontal Swelling Ratio in Hot Water at 80° C.

An acid type of ion exchange membrane was left standing in an air-conditioned chamber controlled at 23° C. and 65% relative humidity for 1 hour or more, then the membrane surface area in dry state was measured. Then, the membrane surface area in swollen state was measured under water by immersing the membrane in hot water at 80° C. for 30 minutes. The horizontal swelling ratio in hot water at 80° C., S_{H} (%), was determined from these values using the following equation:

S_{H}=((A₁−A₂)/A₂)^{0.5}×100

wherein, A₁ is the membrane surface area in swollen state (cm²) and A₂ is the membrane surface area in dry state (cm²).

(9) Water Content

After an acid type of ion exchange membrane was immersed in hot water at 80° C. for 30 minutes, water on membrane surface was wiped off, then the weight in wet state was measured. After that, the weight in dry state was measured taking full consideration not to absorb moisture, after drying at 130° C. for 10 minutes. The water content, W (%), was determined by these values using the following equation:

W=(Wₐ−W_{b})/W_{b}×100

wherein, Wₐ is the weight in wet state (g) and W_{b} is the weight in dry state (g).

(10) Equivalent Weight

About 2 to 10 cm² of an acid type of ion exchange membrane was dipped in 50 ml of a saturated NaCl aqueous solution at 25° C. The solution was left standing for 10 minutes while stirred, then neutralized by titration with 0.01 N sodium hydroxide aqueous solution using phenolphthalein as an indicator. The Na type of ion exchange membrane obtained after the neutralization was rinsed with pure water, then vacuum dried and weighed. The equivalent weight, EW (g/eq), was obtained by the following formula:

EW=(W/M)−22

wherein, M is the equivalent of sodium hydroxide required for neutralization (mmol); W is the weight of the Na type of ion exchange membrane (mg).

(11) Melt Flow Index

MI (g/10 min) is a melt flow index of an ion exchange fluorocarbon resin precursor measured at 270° C. with 2.16 kg of weight in accordance with JIS K 7210.

(12) Strength Retention in Hot Water at 80° C.

An acid type of ion exchange membrane was immersed in hot water at 80° C. for 1 hour or more, then left standing in an air-conditioned chamber at 23° C. and 65% relative humidity for 1 hour or more, and the equivalent puncture strength was measured. The strength retention in hot water at 80° C. (%) was determined by a ratio of equivalent puncture strengths before and after immersion in hot water.

(13) Real Stretching Ratio

The real stretching ratio was determined from membrane thickness T_{b} of precursor membrane before stretching and membrane thickness Tₐ in measuring equivalent puncture strength, using the following equation:

Real stretching ratio=(T_{b}/Tₐ)^{0.5}

### EXAMPLE 1

### Stretching at Low Temperature and High Stretching Ratio

An ion exchange fluorocarbon resin precursor (EW: 950, MI: 20) consisting of a copolymer of a fluorinated vinyl compound and a fluorinated olefin having the above-described general formulas (see the section of raw polymers) (wherein, L is CF₃; n is 1; m is 2; Z is F; and W is SO₂F) was used for film-formation by a T-die method to obtain a precursor membrane with a thickness of 110 μm. Said precursor membrane was subjected to simultaneous biaxial stretching by 2×2 times at a stretching temperature of 25° C. using a simplified compact type of tenter to obtain an oriented membrane. After stretching, said oriented membrane was immersed in a hydrolysis bath (DMSO:KOH:water=5:30:65) heated at 95° C. for 1 hour, while maintained under constraint in stretched state on the simplified compact type of tenter to obtain an ion exchange fluorocarbon resin membrane with metal salt type of ion exchange groups. Then, the membrane was washed sufficiently with water and immersed in a 2N HCl bath heated at 65° C. for 15 minutes to obtain an ion exchange fluorocarbon resin membrane with acid type of ion exchange groups. The membrane was washed sufficiently with water and dried. Said dried membrane was released from the constraint and sandwiched between two stainless steel frames with an open square shape to fix the membrane so that only the peripheral part of the membrane was held. Then, the thus fixed dry membrane was heat treated in an oven at 200° C. for 40 seconds. Subsequently, the membrane was taken out from the oven and immersed in 2N HCl at 25° C. for 15 minutes for washing treatment. Finally, excess HCl adhered to the membrane surface was washed off sufficiently with water, followed by drying to obtain a dry membrane with a thickness of 24.0 μm. The above-described characteristic tests (1) to (11) were performed on the ion exchange fluorocarbon resin membrane thus obtained. The results of the measurements are shown in Table 1.

### EXAMPLE 2

### Stretching at Low Temperature and Low Stretching Ratio

An ion exchange fluorocarbon resin membrane with a thickness of 37.6 μm was obtained using a similar method as in Example 1 except that the stretching ratio was 1.3×1.3 times. The results of the above measurements on the membrane obtained are shown in Table 1.

### EXAMPLE 3

### Stretching at High Temperature and High Stretching Ratio

An ion exchange fluorocarbon resin membrane with a thickness of 16.2 μm was obtained using a similar method as in Example 1 except that the stretching temperature was 65° C. and the stretching ratio was 4×4 times. The results of the above measurements on the membrane obtained are shown in Table 1.

### EXAMPLE 4

### Without Washing Treatment

An ion exchange fluorocarbon resin membrane with a thickness of 26.6 μm was obtained using a similar method as in Example 1 except that washing treatment was not performed. The results of the above measurements on the membrane obtained are shown in Table 1.

### COMPARATIVE EXAMPLE 1

### Non-Oriented Membrane

An ion exchange fluorocarbon resin membrane with a thickness of 30.2 μm was obtained by film-formation of the same ion exchange fluorocarbon resin precursor (EW: 950, MI: 20) as in Example 1, using a T-die method, followed by hydrolysis under a non-oriented state. The results of the measurements on said ion exchange fluorocarbon resin membrane are shown in Table 2.

### COMPARATIVE EXAMPLE 2

### Free Saponification without Constraint

An ion exchange fluorocarbon resin precursor (EW: 950, MI: 20) consisting of a copolymer of a fluorinated vinyl compound and a fluorinated olefin having the above-described general formulas (see the section of raw polymers) (wherein, L is CF₃; n is 1; m is 2; Z is F; and W is SO₂F) was used for film-formation by a T-die method to obtain a precursor membrane with a thickness of 110 μm. Said precursor membrane was subjected to simultaneous biaxial stretching by 2×2 times at a stretching temperature of 25° C. using a simplified compact type of tenter to obtain an oriented membrane. After stretching, said oriented membrane was taken out from the simplified compact type of tenter. The membrane greatly shrinked on this occasion. The membrane was then immersed, under a non-constraint condition, in a hydrolysis bath (DMSO:KOH:water=5:30:65) heated at 95° C. for 15 minutes to obtain an ion exchange fluorocarbon resin membrane with metal salt type of ion exchange groups. Then, the membrane was washed sufficiently with water and immersed in a 2N HCl bath heated at 65° C. for 15 minutes to obtain an ion exchange fluorocarbon resin membrane with acid type of ion exchange groups. The membrane was washed with water sufficiently, followed by drying to obtain a dry membrane with a thickness of 106.0 μm. The results of the measurements on the ion exchange fluorocarbon resin membrane obtained are shown in Table 2.

### COMPARATIVE EXAMPLE 3

### Without Heat Treatment

An ion exchange fluorocarbon resin membrane with a thickness of 24.8 μm was obtained using a similar method as in Example 1 except that heat treatment and washing treatment were not performed. The results of the above measurements on the membrane obtained are shown in Table 2.

### EXAMPLE 5

### Stretching of Ion Exchange Membrane

An ion exchange fluorocarbon resin precursor (EW: 950, MI: 20) consisting of a copolymer of a fluorinated vinyl compound and a fluorinated olefin having the above-described general formulas (see the section of raw polymers) (wherein, L is CF₃; n is 1; m is 2; Z is F; and W is SO₂F) was used for film-formation by a T-die method to obtain a precursor membrane with a thickness of 110 μm. Said precursor membrane was immersed in a hydrolysis bath (DMSO:KOH:water=5:30:65) heated at 95° C. for 1 hour to obtain an ion exchange fluorocarbon resin membrane with metal salt type of ion exchange groups. Then, the membrane was washed sufficiently with water and immersed in a 2N HCl bath heated at 65° C. for 16 hours or more to obtain an ion exchange fluorocarbon resin membrane with acid type of ion exchange groups. The membrane was washed sufficiently with water and dried. Said dry membrane was subjected to simultaneous biaxial stretching by 2×2 times at a stretching temperature of 125° C. using a simplified compact type of tenter to obtain an oriented membrane. After stretching, said dried membrane was taken out of the simplified compact type of tenter, and sandwiched between two stainless steel frames with an open square shape to fix the membrane so that only the peripheral part of the membrane was held. Then, thus fixed oriented membrane was heat treated in an oven at 200° C. for 40 seconds. Subsequently the membrane was taken out from the oven and immersed in 2N HCl at 25° C. for 15 minutes for washing treatment. Finally, excess HCl adhered to the membrane surface was washed off sufficiently with water, followed by drying to obtain a dry membrane with a thickness of 28.9 μm. The results of the above-described measurements are shown in Table 3.

### COMPARATIVE EXAMPLE 4

### Stretching of Ion Exchange Membrane, without Heat Treatment and without Washing Treatment

An ion exchange fluorocarbon resin membrane with a thickness of 25.4 μm was obtained using a similar method as in Example 5 except that heat treatment and washing treatment were not performed. The results of the above measurement on the membrane obtained are shown in Table 3. The designation of “-” in Tables 1 to 3 means that measurement was not performed.

TABLE 1

| | Example 1 | Example 2 | Example 3 | Example 4 |
|---|---|---|---|---|
| EW (g/eq) | 950 | 950 | 950 | 950 |
| MI (g/10 min) | 20 | 20 | 20 | 20 |
| Thickness of raw film | 110 | 110 | 200 | 110 |
| (μm) | | | | |
| Stretching temp. (° C.) | 25 | 25 | 25 | 25 |
| Set stretching ratio | 2 × 2 | 1.3 × 1.3 | 4 × 4 | 2 × 2 |
| Real stretching ratio | 2.1 × 2.1 | 1.7 × 1.7 | 3.5 × 3.5 | 2.0 × 2.0 |
| Heat treatment temp. | 200 | 200 | 200 | 200 |
| (° C.) | | | | |
| Heat treatment time (sec) | 40 | 40 | 40 | 40 |
| Membrane thickness | 24.0 | 37.6 | 16.2 | 26.6 |
| (μm) | | | | |
| Equivalent puncture | 500 | 430 | 680 | 500 |
| strength (g/25 μm) | | | | |
| Thermal shrinkage at | 37 | 30 | 43 | 36 |
| 160° C. (%) | | | | |
| Internal resistance | 0.13 | — | — | 0.17 |
| (Ωcm²) | | | | |
| Horizontal conductivity | 0.27 | 0.21 | 0.23 | 0.19 |
| (S/cm) | | | | |
| Ion conductivity | 1.23 | 0.95 | 1.05 | 0.86 |
| anisotropy | | | | |
| Vertical swelling ratio | 32.0 | 33.8 | 33.3 | 30.8 |
| (%) | | | | |
| Horizontal swelling ratio | 5.9 | 7.0 | 0.0 | 5.2 |
| (%) | | | | |
| Water content (%) | 31.9 | 31.6 | 31.9 | 28.2 |

TABLE 2

| | Comparative | Comparative | Comparative |
|---|---|---|---|
| | Example 1 | Example 2 | Example 3 |
| EW (g/eq) | 950 | 950 | 950 |
| MI (g/10 min) | 20 | 20 | 20 |
| Thickness of raw film (μm) | — | 110 | 110 |
| Stretching temp. (° C.) | — | 25 | 25 |
| Set stretching ratio | — | 2 × 2 | 2 × 2 |
| Real stretching ratio | 1.0 × 1.0 | 1.0 × 1.0 | 2.1 × 2.1 |
| Heat treatment temp. (° C.) | Not applied | Not applied | Not applied |
| Heat treatment time (sec) | Not applied | Not applied | Not applied |
| Membrane thickness (μm) | 30.2 | 106.0 | 24.8 |
| Equivalent puncture | 280 | 250 | 540 |
| strength (g/25 μm) | | | |
| Thermal shrinkage at | 3 | 3 | 55 |
| 160° C. (%) | | | |
| Internal resistance (Ωcm²) | 0.11 | — | — |
| Horizontal conductivity | 0.22 | 0.22 | 0.28 |
| (S/cm) | | | |
| Ion conductivity anisotropy | 1.00 | 1.00 | 1.27 |
| Vertical swelling ratio (%) | 13.4 | 13.8 | 26.5 |
| Horizontal swelling ratio (%) | 13.6 | 15.2 | 3.8 |
| Water content (%) | 30.1 | 34.9 | 29.5 |

TABLE 3

| | | Comparative |
|---|---|---|
| | Example 5 | Example 4 |
| EW (g/eq) | 950 | 950 |
| MI (g/10 min) | 20 | 20 |
| Thickness of raw film (μm) | 110 | 110 |
| Stretching temp. (° C.) | 125 | 125 |
| Set stretching ratio | 2 × 2 | 2 × 2 |
| Real stretching ratio | 2.0 × 2.0 | 2.1 × 2.1 |
| Heat treatment temp. (° C.) | 200 | Not applied |
| Heat treatment time (sec) | 40 | Not applied |
| Membrane thickness (μm) | 28.9 | 25.4 |
| Equivalent puncture | 470 | 530 |
| strength (g/25 μm) | | |
| Thermal shrinkage at | 37.6 | 53 |
| 160° C. (%) | | |
| Internal resistance (Ωcm²) | — | — |
| Horizontal conductivity | 0.27 | 0.27 |
| (S/cm) | | |
| Ion conductivity | 1.23 | 1.23 |
| anisotropy | | |
| Vertical swelling | 33.3 | 94.3 |
| ratio (%) | | |
| Horizontal swelling | 8.0 | −11.1 |
| Ratio (%) | | |
| Water content (%) | 32.9 | 34.6 |

### EXAMPLES 6 TO 9

### Heat Treatment in Short Time

Ion exchange fluorocarbon resin membranes were obtained using a similar methods as in Example 1 to 5 except that the heat treatment conditions were 200° C.×10 seconds. The results of the above measurements on the membranes obtained are shown in Table 4.

TABLE 4

| | Example 6 | Example 7 | Example 8 | Example 9 |
|---|---|---|---|---|
| EW (g/eq) | 950 | 950 | 950 | 950 |
| MI (g/10 min) | 20 | 20 | 20 | 20 |
| Thickness of raw film | 110 | 110 | 110 | 110 |
| (μm) | | | | |
| Stretching temp. (° C.) | 25 | 25 | 25 | 125 |
| Set stretching ratio | 2 × 2 | 1.3 × 1.3 | 2 × 2 | 2 × 2 |
| Real stretching ratio | 2.1 × 2.1 | 1.5 × 1.5 | 2.2 × 2.2 | 2.5 × 2.5 |
| Heat treatment temp. | 200 | 200 | 200 | 200 |
| (° C.) | | | | |
| Heat treatment time (sec) | 10 | 10 | 10 | 10 |
| Membrane thickness | 24.3 | 47.3 | 23.0 | 17.3 |
| (μm) | | | | |
| Equivalent puncture | 440 | 370 | 460 | 540 |
| strength (g/25 μm) | | | | |
| Strength retention (%) | 95 | 93 | 95 | 82 |
| Thermal shrinkage: | 29 | 30 | 26 | 36 |
| air (%) | | | | |
| Thermal shrinkage: | 14 | 18 | 14 | 18 |
| oil (%) | | | | |
| Horizontal conductivity | 0.25 | 0.21 | 0.21 | 0.21 |
| (S/cm) | | | | |
| Ion conductivity | 1.14 | 0.95 | 0.95 | 0.95 |
| anisotropy | | | | |
| Vertical swelling | 36.6 | 41.9 | 23.3 | 38.6 |
| ratio (%) | | | | |
| Horizontal swelling | 11.4 | 10.0 | 10.5 | 8.0 |
| ratio (%) | | | | |
| Water content (%) | 32.2 | 34.3 | 28.8 | 28.5 |

### EXAMPLE 10

### Ion Exchange Resin Precursor with Low EW

An ion exchange fluorocarbon resin membrane was obtained using a similar method as in Example 6 except that an ion exchange fluorocarbon resin precursor consisting of a copolymer of a fluorinated vinyl compound and a fluorinated olefin having the above-described general formulas (see the section of raw polymers) (wherein, L is CF₃; n is 0; m is 2; Z is F; and W is SO₂F), stretching temperature of 85° C. and stretching ratio of 2×2 times were used. The results of the above measurements on the membrane obtained are shown in Table 5.

TABLE 5

| | Example 10 |
|---|---|
| EW (g/eq) | 710 |
| MI (g/10 min) | 3 |
| Thickness of raw film (μm) | 110 |
| Stretching temp. (° C.) | 85 |
| Set stretching ratio | 2 × 2 |
| Real stretching ratio | 2.2 × 2.2 |
| Heat treatment temp. (° C.) | 200 |
| Heat treatment time (sec) | 10 |
| Membrane thickness (μm) | 22.3 |
| Equivalent puncture | 550 |
| strength (g/25 μm) | |
| Strength retention (%) | 98 |
| Thermal shrinkage: air (%) | 28 |
| Thermal shrinkage: oil (%) | 15 |
| Horizontal conductivity (S/cm) | 0.25 |
| Ion conductivity anisotropy | — |
| Vertical swelling ratio (%) | 66.0 |
| Horizontal swelling ratio (%) | 10.2 |
| Water content (%) | 53.1 |

### EXAMPLES 11 TO 15

### Effects of Heat Treatment Conditions

Ion exchange fluorocarbon resin membranes were obtained using a similar method as in Example 6 except that the stretching temperature and heat treatment conditions were set as shown in Table 6. The results of the above measurements on the membranes obtained are shown in Table 6.

TABLE 6

| | Example 11 | Example 12 | Example 13 | Example 14 | Example 15 |
|---|---|---|---|---|---|
| EW (g/eq) | 950 | 950 | 950 | 950 | 950 |
| MI (g/10 min) | 20 | 20 | 20 | 20 | 20 |
| Thickness of raw film (μm) | 110 | 110 | 110 | 110 | 110 |
| Stretching temp. (° C.) | 65 | 25 | 65 | 25 | 25 |
| Set stretching ratio | 2 × 2 | 2 × 2 | 2 × 2 | 2 × 2 | 2 × 2 |
| Real stretching ratio | 2.1 × 2.1 | 2.1 × 2.1 | 2.1 × 2.1 | 2.3 × 2.3 | 2.1 × 2.1 |
| Heat treatment temp. (° C.) | 160 | 170 | 200 | 160 | 170 |
| Heat treatment time (sec) | 900 | 180 | 10 | 300 | 60 |
| Membrane thickness (μm) | 26.0 | 26.0 | 26.0 | 21.0 | 24.7 |
| Equivalent puncture | 410 | 440 | 450 | 490 | 470 |
| strength (g/25 μm) | | | | | |
| Strength retention (%) | 97 | 95 | 94 | 95 | 99 |
| Thermal shrinkage: air (%) | 20 | 25 | 34 | 27 | 35 |
| Thermal shrinkage: oil (%) | 10 | 12 | 16 | 11 | 14 |
| Horizontal conductivity (S/cm) | 0.23 | 0.24 | 0.22 | 0.22 | 0.24 |
| Ion conductivity anisotropy | 1.05 | 1.09 | 1.00 | 1.00 | 1.09 |
| Vertical swelling ratio (%) | 25.9 | 31.6 | 33.6 | 37.6 | 33.9 |
| Horizontal swelling ratio (%) | 11.7 | 11.2 | 10.7 | 7.5 | 8.4 |
| Water content (%) | 25.7 | 27.6 | 32.7 | 27.4 | 29.5 |

### EXAMPLES 16 TO 17

### Stretching of Various Ion Exchange Resins

Ion exchange fluorocarbon resin membranes were obtained using a similar method as in Example 9 except that the EW and MI of ion exchange fluorocarbon resin precursors, as well as stretching and heat treatment conditions were set as shown in Table 7. The results of the above measurements on the membranes obtained are shown in Table 7.

Ion exchange fluorocarbon resin membranes (non-stretched membranes) obtained using a similar method as in Comparative Example 1 except that the same precursors as in Examples 16 and 17 were used, had horizontal ion conductivities at 80° C. of 0.18 S/cm and 0.12 S/cm, respectively.

TABLE 7

| | Example 16 | Example 17 |
|---|---|---|
| EW (g/eq) | 1,025 | 1,250 |
| MI (g/10 min) | 20 | 20 |
| Thickness of raw film (μm) | 110 | 110 |
| Stretching temp. (° C.) | 125 | 125 |
| Set stretching ratio | 2 × 2 | 2 × 2 |
| Real stretching ratio | 2.0 × 2.0 | 1.5 × 1.5 |
| Heat treatment temp. (° C.) | 200 | 200 |
| Heat treatment time (sec) | 10 | 10 |
| Membrane thickness (μm) | 27.0 | 46.5 |
| Equivalent puncture | 550 | 430 |
| strength (g/25 μm) | | |
| Strength retention (%) | 88 | 83 |
| Thermal shrinkage: | 30 | 28 |
| air (%) | | |
| Thermal shrinkage: oil (%) | 18 | 15 |
| Horizontal conductivity | 0.20 | 0.14 |
| (S/cm) | | |
| Ion conductivity | — | — |
| anisotropy | | |
| Vertical swelling | 32.0 | 32.5 |
| Ratio (%) | | |
| Horizontal swelling | 6.7 | 0.8 |
| Ratio (%) | | |
| Water content (%) | 22.7 | 17.4 |

### EXAMPLE 18

### Stretching of Various Ion Exchange Resin Precursors

An ion exchange fluorocarbon resin membrane was obtained using a similar method as in Example 6 except that the EW and MI of ion exchange fluorocarbon resin precursors, as well as stretching and heat treatment conditions were set as shown in Table 8. The results of the above measurement on the membranes obtained are shown in Table 8.

TABLE 8

| | Example 18 |
|---|---|
| EW (g/eq) | 1,025 |
| MI (g/10 min) | 20 |
| Thickness of raw film (μm) | 110 |
| Stretching temp. (° C.) | 25 |
| Set stretching ratio | 2 × 2 |
| Real stretching ratio | 2.4 × 2.4 |
| Heat treatment temp. (° C.) | 160 |
| Heat treatment time (sec) | 300 |
| Membrane thickness (μm) | 19.4 |
| Equivalent puncture | 600 |
| strength (g/25 μm) | |
| Strength retention (%) | 96 |
| Thermal shrinkage: air (%) | 30 |
| Thermal shrinkage: oil (%) | 10 |
| Horizontal conductivity (S/cm) | 0.21 |
| Ion conductivity anisotropy | — |
| Vertical swelling ratio (%) | 34.7 |
| Horizontal swelling ratio (%) | 7.6 |
| Water content (%) | 25.5 |

### COMPARATIVE EXAMPLE 5

### Without Heat Treatment; Stretching of Ion Exchange Resin Precursor

An ion exchange fluorocarbon resin membrane was obtained using a similar method as in Comparative Example 3 except that the stretching conditions were set as shown in Table 9. The results of the above measurements on the membrane obtained are shown in Table 9.

TABLE 9

| | Comparative | Comparative | Comparative |
|---|---|---|---|
| | Example 5 | Example 6 | Example 7 |
| EW (g/eq) | 950 | 1,025 | 1,250 |
| MI (g/10 min) | 20 | 20 | 20 |
| Thickness of raw film (μm) | 110 | 110 | 110 |
| Stretching temp. (° C.) | 65 | 125 | 125 |
| Set stretching ratio | 2 × 2 | 2 × 2 | 2 × 2 |
| Real stretching ratio | 2.0 × 2.0 | 2.1 × 2.1 | 2.0 × 2.0 |
| Heat treatment temp. (° C.) | Not applied | Not | Not applied |
| | | applied | |
| Heat treatment time (sec) | Not applied | Not applied | Not applied |
| Membrane thickness (μm) | 28.0 | 24.9 | 28.0 |
| Equivalent puncture | 470 | 540 | 540 |
| strength (g/25 μm) | | | |
| Strength retention (%) | 97 | 87 | 79 |
| Thermal shrinkage: air (%) | 49 | 48 | 45 |
| Thermal shrinkage: oil (%) | 32 | 45 | 36 |
| Horizontal conductivity | 0.21 | 0.20 | 0.15 |
| (S/cm) | | | |
| Ion conductivity anisotropy | 0.95 | — | — |
| Vertical swelling ratio (%) | 30.8 | 95.6 | 72.0 |
| Horizontal swelling ratio (%) | 11.9 | −7.1 | −8.0 |
| Water content (%) | 29.2 | 32.1 | 21.8 |

### COMPARATIVE EXAMPLE 6 TO 7

### Without Heat Treatment, Stretching of Ion Exchange Resin

Ion exchange fluorocarbon resin membranes were obtained using a similar method as in Comparative Example 4 except that the stretching conditions were set as shown in Table 9. The results of the above measurements on the membranes obtained are shown in Table 9.

### INDUSTRIAL APPLICABILITY

An ion exchange fluorocarbon resin membrane of the present invention has greatly improved effects on yield in a large scale production, because of far more superior mechanical strength than a non-oriented membrane, providing good handling, in particular, in membrane thinning, while maintaining good dimensional stability and ion conductivity. Therefore, an ion exchange fluorocarbon resin membrane of the present invention can be suitably used, in particular, as an ion exchange membrane for a fuel cell.

1. An ion exchange fluorocarbon resin membrane having a membrane thickness of 1 to 500 μm, an equivalent puncture strength of at least 300 g and a thermal shrinkage in air at 160° C. of 45% or less.

2. An ion exchange fluorocarbon resin membrane in accordance with claim 1, wherein a horizontal ion conductivity at 80° C. is 0.10 S/cm or more.

3. An ion exchange fluorocarbon resin membrane in accordance with claim 1 or 2, wherein a horizontal swelling in hot water at 80° C. is from −10% to 30%.

4. An ion exchange fluorocarbon resin membrane in accordance with any one of claims 1 to 3, wherein a strength retention ratio in hot water at 80° C. is at least 80%.

5. An ion exchange fluorocarbon resin membrane in accordance with any one of claims 1 to 4, wherein an ion conductivity anisotropy in hot water at 80° C. is 1.00 or more.

6. A method for manufacturing an ion exchange fluorocarbon resin membrane from an ion exchange fluorocarbon resin precursor, comprising heat treatment of an ion exchange fluorocarbon resin membrane after orientation at a temperature not lower than α-dispersion temperature.

7. A method in accordance with claim 6, comprising:
1) a step for film-formation of an ion exchange fluorocarbon resin precursor containing an ion exchange group precursor;
2) a step for orientation of said precursor membrane;
3) a step for obtaining an ion exchange resin membrane by hydrolyzing an ion exchange group precursor under a constraint to maintain an oriented state of said precursor membrane; and
4) a step for heat treatment of said ion exchange membrane under a constraint.

8. A method in accordance with claim 6, comprising:
1) a step for film-formation of an ion exchange fluorocarbon resin precursor containing an ion exchange group precursor;
2) a step for obtaining an ion exchange membrane by hydrolyzing an ion exchange group precursor of said precursor membrane;
3) a step for orientation of said ion exchange membrane; and
4) a step for heat treatment of said ion exchange membrane under a constraint.

9. A method in accordance with any one of claims 6 to 8, which after said step for heat treatment 4), further comprises:
5) a step for washing the membrane.

10. A method in accordance with claim 9, wherein said step for washing 5) comprises at least partially a step for contacting with an acidic aqueous solution.

11. An ion exchange fluorocarbon resin membrane prepared by a method in accordance with any one of claims 6 to 10.

12. A membrane/electrode assembly equipped with an ion exchange fluorocarbon resin membrane in accordance with any one of claims 1 to 5 and 11.

13. A solid polyelectrolyte type of fuel cell equipped with an ion exchange fluorocarbon resin membrane in accordance with any one of claims 1 to 5 and 11.
